(19) United States
(12) Patent Application Publication
(10) Pub. No.: US 2008/0302256 A1
(43) Pub. Date: Dec. 11, 2008

(54) METHOD OF APPLYING INDICIA TO PLASTIC PARTS

(76) Inventor: Diethelm Hirz, Neunkirchen (DE)

Correspondence Address: K.F. ROSS P.C., 5683 RIVERDALE AVENUE, SUITE 203 BOX 900, BRONX, NY, 10471-0900, US

(21) Appl. No.: 12/136,298

(22) Filed: Jun. 10, 2008

(30) Foreign Application Priority Data
Feb. 14, 2007 (DE) 102007007871.6
Feb. 12, 2008 (DE) 102008008749.1

(51) Int. Cl. B44C 1/24

(52) U.S. Cl. 101/32

(57) ABSTRACT

The invention relates to a method of applying indicia such as labels, text, logos, bar codes, or the like to plastic parts, in particular storage and transport containers, palettes, or trays. The goal is to create a cost-effective method of the application of multi-colored and consistently easily readable, durable printing to the plastic parts mentioned above with a low level of logistical expenditure. In order to attain this goal in a combined hot embossing and thermotransfer printing unit, first a background color is applied as contrast to the plastic part that has been removed from a production machine, using hot embossing and then, in the same location, the indicia is applied using thermotransfer printing.

The invention relates to a method of applying indicia to plastic substrates such as labels, text, logos, bar codes, or the like, in particular to storage and transport containers, palettes, or trays that may in particular be produced by injection molding or using extrusion and deep-drawing.

DE 10 2005 003 721 discloses the application of indicia or writing to the visible outer surfaces of transport boxes, palettes, and trays in three steps in an injection molding machine or mold. In the first step, the plastic part is injection-molded, then, in a second step, one part of the injection mold is changed, and, in the third step, the plastic forming the writing is pressed in via a second, separate supply channel. The injection mold needed for this method requires two interchangeable mold parts in the wall carrying the writing.

Additional common prior art includes the application of labels to plastic containers or parts using screen printing, hot embossing, or injection embossing methods as well as in-mold labeling (IML) methods and thermotransfer printing. In addition, printing may be adhered to the objects.

Screen printing is not only time consuming, it also has the disadvantage that it guarantees only a low level of durability of the printing. Namely, the printing may, for example, be scratched or even partially removed by rubbing against sharp-edged objects. Thus, over time, the printing become unsightly and is no longer recognizable, which leads to a considerable decline in legibility, especially in the case of bar codes.

Hot embossing and injection embossing are very inflexible because, once engraved, the printing or stamp is no longer changeable. In addition, multi-colored printing may be applied by means of the injection embossing process only at great expense.

Although the in-mold labeling method allows for the possibility of using multi-colored films, the extra equipment required for such a process is very costly. Moreover, printing or labels that constantly change, such as the successive numbers on bar codes, must be produced and made available in a laborious fashion because the bar codes must be numbered before their application.

The thermotransfer printing method that allows for a large degree of individuality with regard to the thermotransfer films as well as the materials to be imprinted, has the disadvantage that only monochromatic printing is possible. Thus, in the case of bar codes that have been applied, contrast is frequently not sufficient to allow them to be read in an error-free fashion. Ultimately, even in the case of graphic applications (logos or the like), it is not possible to provide dual-color printing.

In the case of printing applied by adhesion, the disadvantage arises that, due to gas emission and shrinkage of the plastic parts as well as the labels or stickers, application directly after the injection molding process is not possible. Specifically, bubbles may form beneath the sticker that would lead to its being even fully detached or to the bar codes being unreadable by scanners. Therefore, freshly injected plastic parts must be stored for approximately 48 to 72 hours before labels or stickers may be applied. This leads to logistical problems (for example, large storage space needs), especially in the case of large plastic parts.

The object of the invention is to prevent the disadvantages of the prior art described above and to create a method of the type mentioned above that allows for a cost-effective application of multi-colored and consistently easily legible, resilient indicia onto plastic parts with a reduced logistical expenditure.

This object is attained according to the invention in that, in a combined hot embossing and thermotransfer printing unit, first a background color is applied as contrast to a plastic part that has been removed from a production machine using hot embossing and then, in the same location, the indicia is applied using thermotransfer printing. Because two different methods (hot embossing and thermotransfer printing) are combined according to the invention, high-contrast printing may be applied to the plastic part directly and immediately after production, for example, via an injection molding process, i.e., without intermediate storage, in one production step.

In the case of bar codes, one advantageous embodiment provides for a white surface to be embossed as the background color and then the appropriate writing and bar codes to be applied in black. This guarantees that there is always contrast by means of which the bar codes may be scanned with quality and certainty. By virtue of the thermotransfer printing, the bar codes are so flexible that, if necessary, it is simple for each subsequent bar code to have a different structure.

Here, it lies within the scope of the invention for labels such as text and/or logos to be applied in a dual-color printing process. In the hot-embossing process, any desired background color is applied and, subsequently, the logo or writing is applied at the same location in another color. In any case, the large degree of flexibility of the thermotransfer printing process may be exploited because each image may be generated and manipulated in a computer without much effort, such that expensive engraved masters may be completely omitted.

Another advantageous recommendation of the invention provides for the indicia to be sealed by means of a subsequent pressure. The seal effectively makes sure the indicia (bar codes, the logo, or the writing) remains easily readable even after being scratched and, in addition, prevents the durability of the indicia from being negatively influenced by washing processes or chemical effects.

Additional features and details of the combined and unified methods of hot embossing and thermotransfer printing may be found in the claims.

1-3. (canceled)

4. A method of applying indicia such as labels, text, logos, bar codes, or the like to a plastic parts, the method comprising the steps of:
hot-embossing a background color to a surface of the part and thereafter
thermotransfer printing the indicia in a color contrasting with the background color to the surface over the hot-embossed background color.

5. The method defined in claim 4 wherein the part is in the process of being manufactured in a production machine, the method further comprising the step before the hot-embossing of:
removing the part from the production machine.

6. The method defined in claim 4 wherein the background color is white.

7. The method defined in claim 6 wherein the contrasting color is black.

8. The method defined in claim 4, further comprising the step after thermotransfer printing of:
sealing the surface over the indicia.
